(19) United States
(12) Patent Application Publication
(10) Pub. No.: US 2009/0167961 A1
(43) Pub. Date: Jul. 2, 2009

(54) IMAGE PROCESSING DEVICE

(75) Inventors: Hironori Suzuki, Tokyo (JP); Yasuhiro Yamanaka, Chiba (JP)

Correspondence Address: FITCH EVEN TABIN AND FLANNERY, 120 SOUTH LASALLE STREET, SUITE 1600, CHICAGO, IL, 60603-3406, US

(73) Assignee: SONY COMPUTER ENTERTAINMENT INC., TOKYO (JP)

(21) Appl. No.: 11/909,705

(22) PCT Filed: Jul. 7, 2006
(86) PCT No.: PCT/JP2006/313555

§ 371 Date: Nov. 19, 2008

(30) Foreign Application Priority Data
Jul. 13, 2005 (JP) 2005-204098

(51) Int. Cl. H04N 9/64

(52) U.S. Cl. 348/718; 348/714; 348/E09.037

(57) ABSTRACT

In an information terminal 10 of the present invention, a read unit 34 reads image data to be displayed from a storage device (20, 50). A display 12 displays an image based on the read image data. An image transformation unit 44 applies image transformation to the displayed image. A background image acquisition unit 60 acquires the image data on the image transformed by the image transformation unit 44 and displayed on the display 12, as background image data to be pasted to the background of the display 12.

### FIELD OF THE INVENTION

The present invention relates to a technology for processing image data, and in particular, to a technology for generating a background image of a display.

### DESCRIPTION OF THE RELATED ART

With advances in the miniaturization and weight reduction of information terminals, it has become common to carry information terminals about. Portable information terminals are typified by PDAs (Personal Digital Assistances). With CPUs of higher speed and memories of higher density, portable game apparatuses commercially available in recent years have also advanced in functionality until they have attained some of the functions of PDAs.

### DISCLOSURE OF THE INVENTION

### Problems to be Solved by the Invention

The prevalence of digital cameras increases the opportunity for users to take pictures more freely than before. One of the uses for captured photographic data is to paste it as a background image (wallpaper) on the desktop of a personal computer. Using a favorite image as the background image on a screen readily provides a viewer with a sense of pleasure when viewing the background image from time to time. It is expected that the use of photographic data as the background image of the display will become common in future even with portable information terminals.

There has conventionally been a technique for creating a background image by processing image data according to the size of the display. If the image data is greater than the display size, the image data is zoomed out to fit the display size. Conversely, if the image data is smaller than the display size, plural copies of the same images are arranged in a matrix so as to fit the display size.

Meanwhile, in order to set part of an image as the background image, it is necessary to first edit the image to create new image data and then set the created image data as the background image. This operation imposes a considerable burden on users. In particular, portable information terminals have input interfaces that are limited in operability as compared to the input interfaces of personal computers. An image editing operation would therefore require considerable effort even if image editing software were installed in the portable information terminals.

It is thus a general purpose of the present invention to provide a technology capable of efficiently creating a background image to be pasted on the background of a display.

### Means to Solve the Problems

To solve the foregoing problem, an image processing apparatus according to one embodiment of the present invention includes: a read unit which reads image data to be displayed from a storage device; a display unit which displays an image based on the read image data; an image transformation unit which applies image transformation to the displayed image; and a background image acquisition unit which acquires image data on the image transformed by the image transformation unit and displayed on the display unit, as background image data to be pasted to a background of the display unit.

Any combinations of the foregoing components, and any conversions of expressions of the present invention from/into methods, apparatuses, systems, recording media, computer programs, and the like are also intended to constitute applicable embodiments of the present invention.

### BRIEF DESCRIPTION OF THE DRAWINGS

FIG. 1 is a diagram showing the appearance of an information terminal;

FIG. 2 is a functional block diagram showing the configuration of the information terminal;

FIG. 3(a) is a diagram showing a first-level menu screen, FIG. 3(b) is a diagram showing a second-level menu screen, and FIG. 3(c) is a diagram showing a third-level menu screen;

FIG. 4(a) is a diagram showing an example of the image to be displayed on the display, FIG. 4(b) is a diagram showing the state where an operation panel is displayed on part of the display, and FIG. 4(c) is a diagram showing examples of icons displayed on the operation panel;

FIG. 5(a) is a diagram showing a screen in which the image shown in FIG. 4(a) is zoomed in, FIG. 5(b) is a diagram showing a screen in which the image shown in FIG. 5(a) is moved, and FIG. 5(c) is a diagram showing a screen in which the image shown in FIG. 4(a) is rotated 90° counterclockwise;

FIG. 6(a) is a diagram showing a screen for inquiring whether or not to set the displayed image as a wallpaper, FIG. 6(b) is a diagram showing a screen when the background image data is being saved, FIG. 6(c) is a diagram showing a screen when the background image data has finished saving, and FIG. 6(d) is a diagram showing an inquiry screen;

FIG. 7 is a diagram showing an example of the background image displayed; and

FIG. 8 is a diagram showing a screen in which a background image registered is pasted to the background of the menu screen shown in FIG. 3(a).

### DESCRIPTION OF REFERENCE NUMERALS

10 . . . information terminal, 12 . . . display, 14 . . . arrow key, 16 . . . button key, 17 . . . pad, 18 . . . L button, 19 . . . R button, 20 . . . memory card, 30 . . . input interface, 32 . . . accepting unit, 34 . . . read unit, 36 . . . menu control unit, 40 . . . display processing unit, 42 . . . decoding processing unit, 44 . . . image transformation unit 46 . . . output buffer unit, 48 . . . synthesis processing unit, 50 . . . storage unit, 60 . . . background image acquisition unit, and 70 . . . operation panel.

### BEST MODE FOR CARRYING OUT THE INVENTION

An image processing apparatus according to the present embodiment efficiently creates a background image, also known as wallpaper. This apparatus is configured to have viewer functions such as, for example, displaying image data relating to photographs on a display and enabling such operations as zoom-in, zoom-out, rotation, and movement of the displayed images.

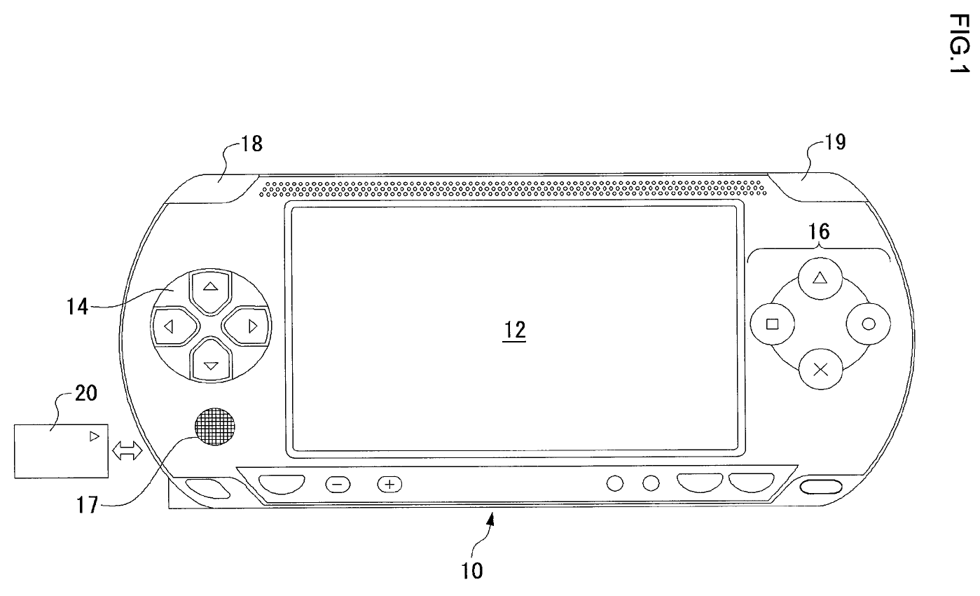

FIG. 1 shows the appearance of an information terminal. The information terminal 10 is a portable electronic apparatus which is capable of displaying photographic image data. In the present embodiment, the information terminal 10 functions as an image processing apparatus. The image data to be displayed may be read from an external storage device which is removably attached to the information terminal 10, or may be read from a built-in internal storage device. In the present embodiment, the external storage device is a memory card 20. The memory card 20 is loaded into a drive (not shown) provided in the information terminal 10. The memory card 20 is a small-sized memory card which can also be removably attached to a digital camera and a cellular phone, and is capable of storing image data. Image data captured by a digital camera and stored in the memory card 20 can then be displayed on a display unit by loading the memory card 20 into the information terminal 10.

The information terminal 10 is provided with a display 12, and an input interface including an arrow key 14, button keys 16, a pad 17, an L button 18, and an R button 19. A user holds the right and left ends of the information terminal 10 with both hands, gives instructions in up, down, right, and left directions by using the arrow key 14 chiefly with the left thumb, and performs various types of operations by using the button keys 16 chiefly with the right thumb. The pad 17 is used to input analog values, and can be moved in any directions from a reference position at the center. The L button 18 and the R button 19 are used when performing respective corresponding processes. The display 12 is the display unit for displaying images etc., and is made of a liquid crystal panel or the like. The information terminal 10 also includes a USB port, an infrared port, and wireless LAN communication facilities. Image data can also be transmitted and received to/from other apparatuses through these ports or communication facilities.

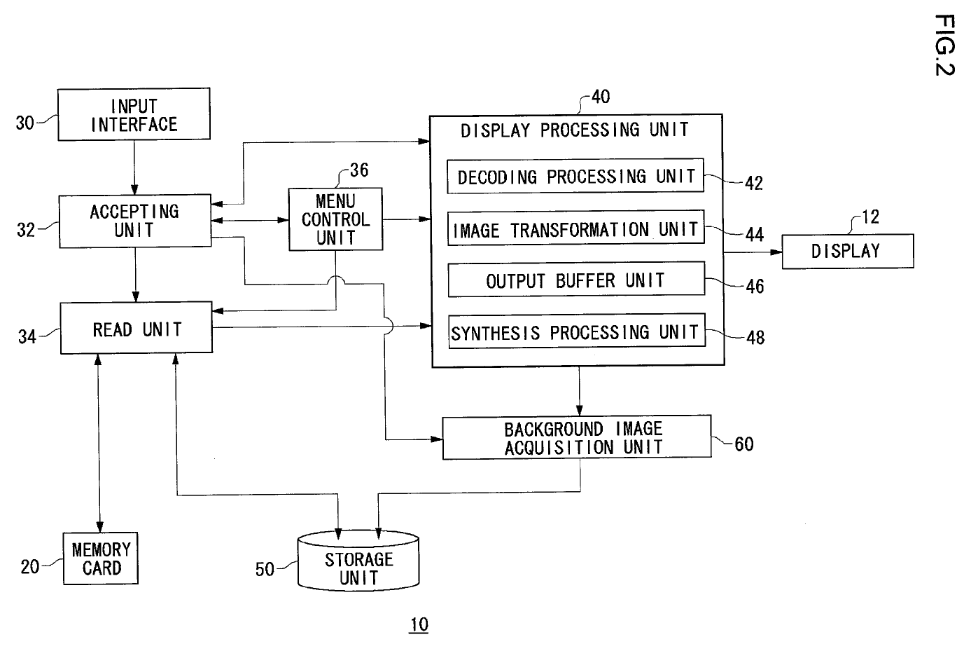

FIG. 2 is a functional block diagram showing the configuration of the information terminal. The information terminal 10 includes the display 12, an input interface 30, an accepting unit 32, a read unit 34, a menu control unit 36, a display processing unit 40, a storage unit 50, and a background image acquisition unit 60. The display processing unit 40 includes a decoding processing unit 42, an image transformation unit 44, an output buffer unit 46, and a synthesis processing unit 48. The input interface 30 is the operating means including the arrow key 14, the button keys 16, the pad 17, the L button 18, and the R button 19. The storage unit 50 is a storage device built into the information terminal 10. The memory card 20 is a removable external storage device. The information terminal 10 uses the memory card 20 and the storage unit 50 as its storage devices. It should be appreciated that the storage unit 50 may be composed of a plurality of types of storage devices.

The information apparatus 10 according to the present embodiment has a background image creating function which is achieved by a CPU, a memory, a program loaded into the memory and the like. Here, the diagram shows functional blocks to be achieved by the cooperation of these elements. The program may be built into the information terminal 10, or may be supplied from outside the apparatus in a form stored in a recording medium. It will thus be understood by those skilled in the art that these functional blocks may be implemented in various forms including hardware alone, software alone, or a combination of these.

The input interface 30 acquires instructions as to menu operations, image display, image transformation, and the like through user operations. Using the input interface 30, the user moves a cursor on an operation screen that appears on the display 12, puts the cursor in a desired position, and presses an enter button to set the content of the instruction. The accepting unit 32 accepts instructions from the user, and transmits the content of the instruction to the individual components, i.e. the read unit 34, the menu control unit 36, the display processing unit 40, and the background image acquisition unit 60.

Based on the instructions relating to menu operation accepted by the accepting unit 32, the menu control unit 36 controls the display of menu screens on the information terminal 10. The menu screens are configured in a hierarchical fashion, and the user selects image data according to the menu screens.

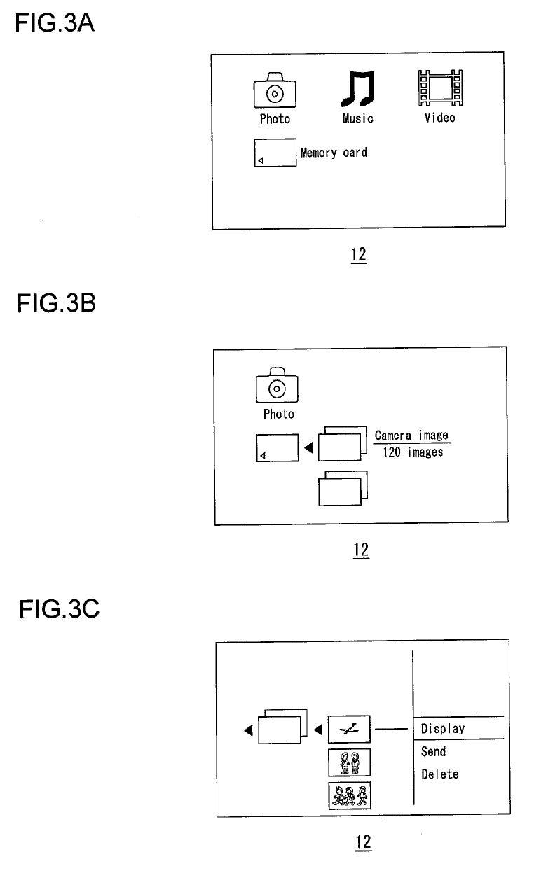

FIG. 3(a) shows a first-level menu screen. The menu screen shows icons, which the user selects using the input interface 30. When the memory card 20 is loaded in the information terminal 10, an icon of the memory card appears on the menu screen. When the memory card 20 is not loaded, the icon of the memory card 20 will not appear.

The read unit 34 reads first-level menu screen data from the storage unit 50, and supplies it to the display processing unit 40. The synthesis processing unit 48 expands the read image data on the first-level menu screen in the output buffer unit 46. The output buffer unit 46 is formed as a texture buffer memory, in which the data to be supplied to the display 12 is expanded. The output buffer unit 46 supplies the expanded image data to a frame buffer memory of the display 12, so that the first-level menu screen is displayed on the display 12.

When the accepting unit 32 accepts user operations on the input interface 30, the menu control unit 36 notifies the display processing unit 40 of the contents of operation. In the display processing unit 40, the synthesis processing unit 48 generates image data that reflects the contents of the operation performed by the user. For example, the synthesis processing unit 48 generates image data such that an icon which the user puts the cursor on is shown in greater size or in different color. The contents of the user operation on the input interface 30 are processed by the synthesis processing unit 48 and successively reflected on the menu screen display.

FIG. 3(b) shows a second-level menu screen. Here, the icon of the memory card is selected, and icons for plural types of data recorded on the memory card 20 are displayed vertically. The read unit 34 reads second-level menu screen data from the storage unit 50, and supplies it to the display processing unit 40. The synthesis processing unit 48 expands the read image data on the second-level menu screen in the output buffer unit 46. The output buffer unit 46 supplies the expanded image data to the display 12, so that the second-level menu screen is displayed on the display 12. Here, the menu control unit 36 supplies a read instruction to the read unit 34 so as to read the number of camera images from the memory card 20. The number of camera images read is displayed on the menu screen.

FIG. 3(c) shows a third-level menu screen. Here, an icon of camera images is selected, and some of the camera images recorded on the memory card 20 are thumbnailed. When the user presses the arrow key 14 in the up or down direction, the thumbnails are switched so that thumbnails of new images appear. Processes which can be performed on the thumbnail images are listed to the right of the thumbnails. Here, when the user selects “display,” the accepting unit 32 sends information that identifies the image data to be displayed, or the image data on the original image of the display-instructed thumbnail, to the read unit 34. The read unit 34 reads the image data from the memory card 20.

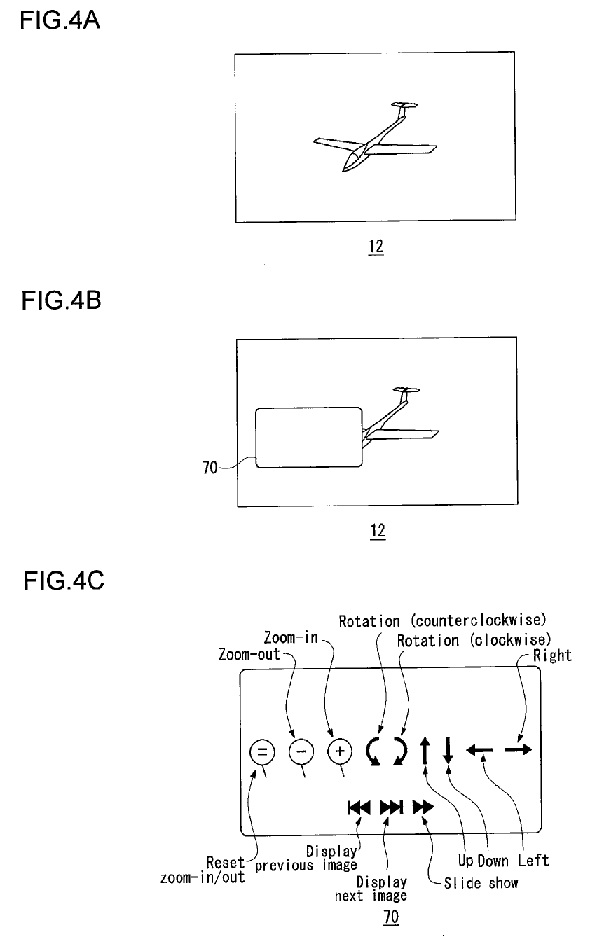

FIG. 4(a) shows an example of the image to be displayed on the display. The read unit 34 supplies the read image data to the display processing unit 40. In general, image data is compressed and/or encoded when stored into the memory card 20. If so, the decoding processing unit 42 then decodes the encoded image data. The decoding processing unit 42 sends the decoded image data to the synthesis processing unit 48. The synthesis processing unit 48 expands this image data in the output data unit 46. The display 12 of the present embodiment has a screen size of, for example, 480 dots horizontally×272 dots vertically. If the original image data is greater than the screen size, the image data is subjected to zoom-out processing so that it is fully displayed on the display 12. Here, the image data is preferably zoomed out so that at least either one of the numbers of dots in the horizontal and vertical directions of the image data coincides with the maximum number of dots in the horizontal or vertical direction of the screen size. In the shown example, the original image data has an aspect ratio of 480:272, the same as the aspect ratio of the display 12. The whole image is thus displayed on the entire screen of the display 12.

The output buffer unit 46 may be configured to have the same data size as the frame buffer memory of the display 12. In the present embodiment, the output buffer unit 46 is configured to have a data size as required for a screen size of 480 dots horizontally×272 dots vertically. Consequently, when scaling the original image data up or down, it follows that the image data zoomed in or out is expanded in the output buffer 46, and the data in the output buffer unit 46 is supplied to the frame buffer memory of the display 12.

With the information terminal 10 of the present embodiment, the user can apply image transformations to the displayed image. This processing is performed by the image transformation unit 44, based on an image transformation instruction from the user. Specifically, the image transformation unit 44 can apply such image transformations as zoom-in, zoom-out, rotation, and movement to the displayed image based on the instructions from the user.

When the user presses a predetermined display button on the display screen shown in FIG. 4(a), a graphical user interface for image transformation processing, i.e. an operation panel 70, appears. The read unit 34 reads the contents of display of the operation panel 70 from the storage unit 50, and supplies them to the display processing unit 40. The synthesis processing unit 48 places the operation panel 70 in a predetermined position on the display 12 and synthesizes the display image and the operation panel 70. FIG. 4(b) shows the state where the operation panel is displayed on part of the display 12. The operation panel 70 shows an array of icons which represent the contents of processing of image transformation on the image. FIG. 4(c) shows examples of the icons displayed on the operation panel.

The icons shown in the first row are each associated with image transformation processing. When the user selects these icons, the respective corresponding processes of image transformation are performed.

“Release zoom-in/out” icon: restore the image zoomed in/out to its original display size.

“Zoom-out” icon: zoom out the image.

“Zoom-in” icon: zoom in the image.

“Rotation (left)” icon: rotate the image 90° counterclockwise.

“Rotation (right)” icon: rotate the image 90° clockwise.

“Up/Down/Left/Right” icons: move the image to display hidden areas when it is zoomed-in/out or when the display mode is zoom. Note that the possible display modes are normal mode and zoom mode. Either one of these display modes is selected by the user. In normal mode, the image is adjusted to the screen size and displayed without changing the aspect of the image data. In zoom mode, the image is trimmed at the top and bottom or at the right and left so that it is displayed on the entire screen without changing the aspect of the image data.

The icons shown in the second row are used to change the image to be displayed.

“Display previous image” icon: display the previous image.

“Display next image” icon: display the next image.

“Slide show” icon: display images one by one automatically.

It should be appreciated that the instructions for image transformation processing may be given by selecting the icons shown in the first row of the operation panel 70, or may be given without using the operation panel 70. In the information terminal 10, the individual processes of image transformation are associated with single operations or combined operations of the arrow key 14, the button keys 16, the pad 17, the L button 18, and the R button 19. The user can thus operate this input interface 30 to select the contents of processing for image transformation.

When the user operates the input interface 30 to select the contents of processing for image transformation, the accepting unit 32 accepts the image transformation instruction and supplies it to the display processing unit 40. Based on the image transformation instructions supplied, the image transformation unit 44 transforms the image displayed on the display 12.

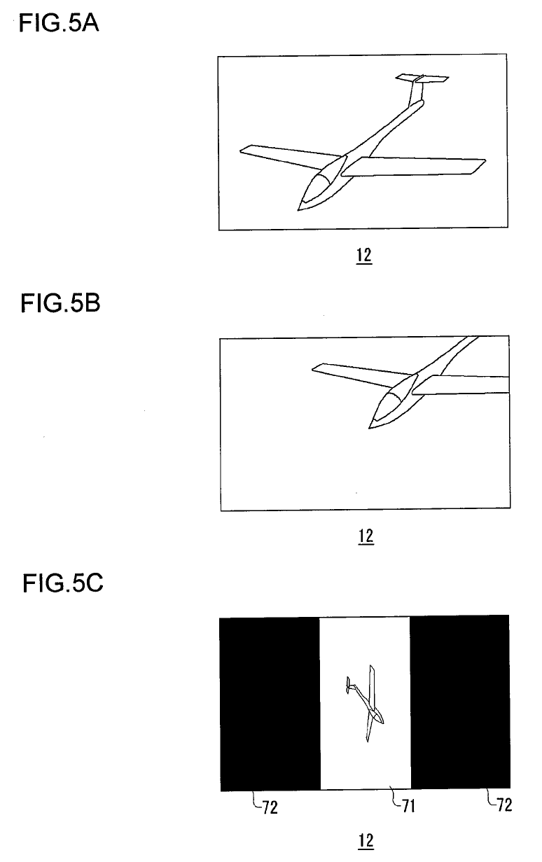

FIG. 5(a) shows a screen in which the image shown in FIG. 4(a) is zoomed in. In the zoom-in processing, the image is zoomed-in in the horizontal and vertical directions around the fixed center.

FIG. 5(b) shows a screen in which the image shown in FIG. 5(a) is moved. The move processing can be performed when the image is zoomed in/out, or when the display mode is set in zoom mode.

FIG. 5(c) shows a screen on which the image shown in FIG. 4(a) is rotated 90° counterclockwise. In the rotation processing, the image is rotated by a predetermined angle around the fixed center of the image. Since the original image of FIG. 4(a) is a horizontally oblong image, it creates margin areas 72 on both right and left sides of an image area 71 at the center when rotated 90° counterclockwise. In consequence, the image is zoomed out for display, and the margin areas 72 are displayed in one color.

As above, the image transformation unit 44 applies image transformation to the display image based on instructions from the user. The user views the image that is subjected to transform processing and displayed on the display 12 while searching for a desired display image to set as the background image (wallpaper). When an image with a preferred composition appears on the display 12 in the course of transformation processing on images, the user presses a predetermined enter button out of the button keys 16. As an example, description will be given of setting the image shown in FIG. 5(b) as the background image.

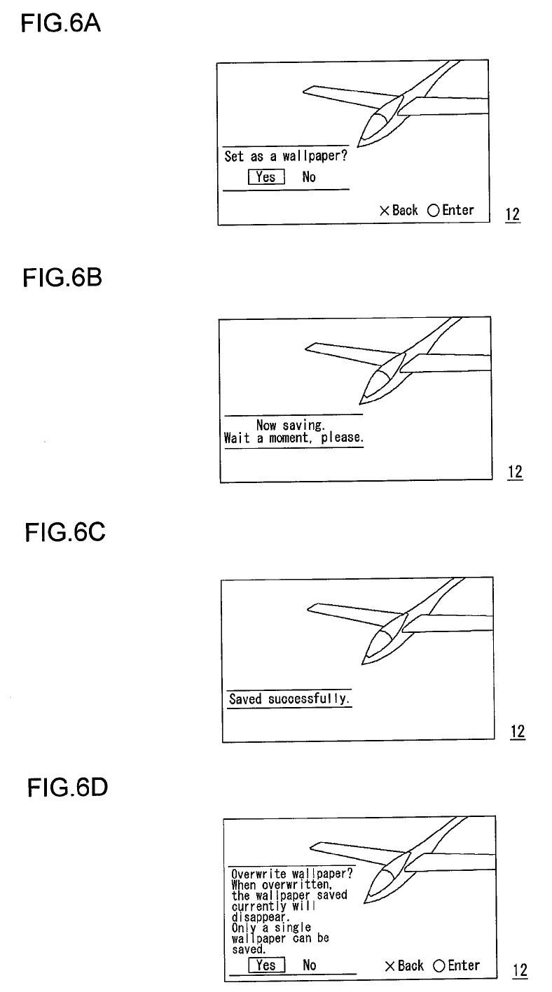

FIG. 6(a) shows a screen for inquiring whether or not to set the displayed image as the wallpaper. If the user presses the enter button when the image shown in FIG. 5(b) is displayed on the display 12, the read unit 34 reads a comment from the storage unit 50. The synthesis processing unit 48 creates image data on the display image on which the comment is superimposed. The user uses the input interface 30 to select “Yes” or “No,” and presses the enter button (in the shown example, the “o button”). When “Yes” is selected and set here, the data on the display image is saved as background image data.

FIG. 6(b) shows a screen when the background image data is being saved. FIG. 6(c) shows a screen when the background image data has finished saving.

When the user presses the enter button (in the shown example, the “o button”) on the inquiry screen shown in FIG. 6(a), the accepting unit 32 accepts the pressing operation as a background image acquisition instruction. The accepting unit 32 notifies this background image acquisition instruction to the background image acquisition unit 60. The background image acquisition unit 60 acquires the image data on the image displayed on the display 12, as background image data to be pasted to the background of the display 12. This display image is the one transformed by the image transformation unit 44. The acquired background image data is saved into the storage unit 50.

The background image acquisition unit 60 may acquire background image data from the data expanded in the output buffer unit 46. While the output buffer unit 46 temporarily stores the display image data and the comment data to be written over the display image, the background image acquisition unit 60 may acquire the background image data by extracting the display image data alone. The background image acquisition unit 60 may also acquire the background image data by extracting the data displayed on the display 12 from the original image data. In this case, the background image acquisition unit 60 may acquire cut information identifying the area to be cut from the original image to form the background image, and acquire the combination of the original image data and the cut information as the background image data. It should be appreciated that the background image data is preferably subjected to predetermined compression processing when saved into the storage unit 50.

As above, since the display image that is transformed by the image transformation unit 44 is simply acquired as the background image, it is possible to reduce the burden imposed on the user in editing the background image. It has conventionally been necessary for the user to perform the procedure of creating a new image by first cutting or otherwise processing a desired area out of an original image, and then setting that image as the background image. With the background image creating technology according to the present embodiment, however, the data on the image that is displayed with image transformation can be simply acquired as the background image. This allows a significant reduction in the burden imposed on the user.

In particular, when this technology is used for an information terminal 10 of the portable type, a background image can easily be created despite the limited resources of the information terminal 10. This is significantly advantageous since costly image editing tools need not be implemented just for the sake of editing the background image.

It should be appreciated that the number of images that can be saved as a background image is limited to one in the information terminal 10 of the present embodiment. The reason for this is that the information terminal 10 is a portable electronic apparatus, and its storage capacity must be used efficiently. Thus, when registering a new background image in the presence of a previously set background image, an inquiry screen shown in FIG. 6(d) is displayed. If “No” is selected and set on this inquiry screen, the former background image remains in effect. If “Yes” is selected and set, the former background image is deleted from the storage unit 50 and the new background image is registered in the storage unit 50.

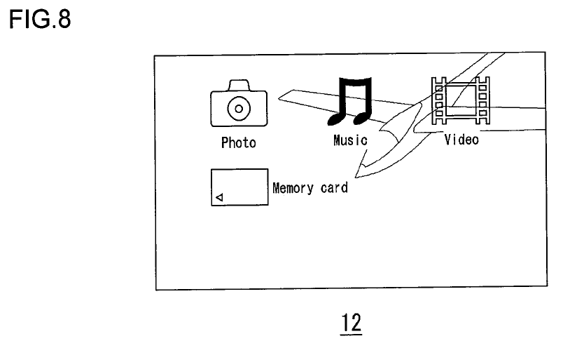

FIG. 8 shows a screen in which the registered background image is pasted to the background of the menu screen shown in FIG. 3(a). Using the background image creating technology of the present embodiment, it is possible for the user to easily create a favorite background image. The read unit 34 reads the background image data from the storage unit 50 and supplies it to the display processing unit 40, and the synthesis processing unit 48 expands the background image data in the output buffer unit 46 and superimposes the menu screen on the background image. This produces the screen shown in FIG. 8.

A description will now be given of the case of setting the image shown in FIG. 5(c) as the background image. In FIG. 5(c), the transformed image is not displayed on the entire area of the display 12, but is displayed with margin areas 72 on both right and left sides. The margin areas 72 are filled with a single colored image. The background image acquisition unit 60 registers the central image area 71 in the storage unit 50 as a background image. When the synthesis processing unit 48 expands that background image data in the output buffer unit 46, it performs processing to fill the margin areas with different background image data.

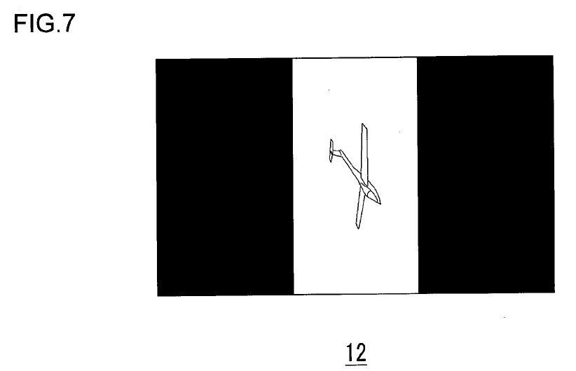

FIG. 7 shows an example of the displayed background image. The background image to be registered is the image area 71 shown in FIG. 5(c). The margin areas 72 are not included in the registered background image. When displaying the background image, the synthesis processing unit 48 expands the read background image data in the output buffer unit 46, and also expands background image data different from the read data for the margin areas. Here, the background image data read from the storage unit 50 is placed in the output buffer unit 46 so that it always lies in the center of the display 12. It should be appreciated that the different background image to be displayed in the margin areas may be ones that produce the visual effect of highlighting the background image at the center, like a monochromatic image as shown in the diagram.

The background image acquisition unit 60 may also acquire one single image synthesized from the image area and the margin areas for the background image. In this case, the background image data is the image data to be displayed on the entire area of the display 12, and the background image is the entire image on the display 12. While the displayed image area 71 (see FIG. 5(c)) is used intactly even in the background image, the color of the margin areas 72 in the display may be changed to an image of different color in the background image.

Up to this point, the present invention has been described with reference to the embodiment thereof. This embodiment has been given solely by way of illustration. It will be understood by those skilled in the art that various modifications may be made to combinations of the foregoing components and processes, and all such modifications are also intended to fall within the scope of the present invention. The present embodiment has shown that the technology of the present invention can effectively be applied to a portable information terminal 10. Nevertheless, the invention is also effectively applicable to information terminals of a stand alone type such as a desktop personal computer. Moreover, the embodiment has illustrated the case where the image data to be displayed is read from a memory card, whereas it might equally be read from the storage unit 50. Furthermore, the image data is not limited to still images but may comprise moving images. In the case of moving images, the moving images may be stopped according to user instructions and the stopped image may be registered as a background image. It should be appreciated that a stopped image may be subjected to image transformation processing before the acquisition of the background image.

### INDUSTRIAL APPLICABILITY

The present invention is applicable to the field of image processing.

What is claimed is:

1. An image processing apparatus comprising:
a read unit which reads image data to be displayed from a storage device;
a display unit which displays an image based on the read image data;
an image transformation unit which applies image transformation to the displayed image; and
a background image acquisition unit which acquires image data on the image transformed by the image transformation unit and displayed on the display unit, as background image data to be pasted to a background of the display unit.

2. The image processing apparatus according to claim 1, further comprising an accepting unit which accepts an instruction from a user, and wherein
the image transformation unit applies such image transformation as zoom-in, zoom-out, rotation, and movement to the displayed image based on the instruction accepted by the accepting unit.

3. A program for making a computer perform the functions of:
reading image data to be displayed from a storage device;
displaying an image on a display unit based on the read image data;
applying image transformation to the displayed image; and
acquiring image data on the image transformed and displayed on the display unit, as background image data to be pasted to a background of the display unit.

4. A computer-readable recording medium containing the program according to claim 3.
